(19) United States
(12) Patent Application Publication
(10) Pub. No.: US 2013/0110526 A1
(43) Pub. Date: May 2, 2013

(54) SYSTEM AND METHOD FOR MONITORING AUTHORIZATION, COMPLIANCE, AND ADHERENCE OF DRUG PRESCRIPTIONS AND TREATMENTS

(71) Applicant: Gitesh PATEL, Bakersfield, CA (US)

(72) Inventor: Gitesh PATEL, Bakersfield, CA (US)

(73) Assignee: Sargas Pharmaceutical Adherence and Compliance International, LLC, Bakersfield, CA (US)

(21) Appl. No.: 13/282,049

(22) Filed: Oct. 26, 2011

(51) Int. Cl. G06Q 50/22

(52) U.S. Cl. 705/2

(57) ABSTRACT

A method for authorizing and monitoring drug prescriptions and treatments for at least one patient is provided. The method includes the steps of providing an agency for coordinating care between the patient and a health care provider; providing a computerized electronic server for authorizing and monitoring drug prescriptions and treatments configured to perform the steps of: receiving a script; verifying insurance information; determining whether the script is dispensed to the patient; and contacting the health care provider when the script is dispensed to the patient; wherein the computerized electronic server is accessible via a device.

### FIELD OF THE INVENTION

The present invention relates to a system and method for authorizing and monitoring drug prescriptions and treatments for at least one patient.

### BACKGROUND OF THE INVENTION

Often times, a health care provider prescribes a patient a drug treatment regimen. The health care provider may discuss the drug treatment regimen with the patient during the patient's office visit. The patient may, however, go home and forget the drug treatment regimen prescribed by the health care provider. Additionally, the patient may forget to take the drug in the manner prescribed (i.e., with or without food, time of day/week/month, with or without medication). As such, many patients need assistance outside of the health care provider's office regarding their drug treatment regimen. This is especially true of cancer patients, that have complex drug treatment regimens and have to take certain drugs consistently. Often times, a patient's health fails due to the lack of drug treatment compliance when the patient leaves the health provider's office. Accordingly, there is a need for a system that provides the patient assistance with his/her drug treatment regimen when he/she leaves the health provider's office.

### SUMMARY OF THE PREFERRED EMBODIMENTS

In accordance with one aspect of the present invention, a method for authorizing and monitoring drug prescriptions and treatments for at least one patient is provided. The method includes the steps of providing an agency for coordinating care between the patient and the health care provider; providing a computerized electronic server for authorizing and monitoring drug prescriptions and treatments configured to perform the steps of: receiving a script; verifying insurance information; determining whether the script is dispensed to the patient; and contacting a health care provider when the script is dispensed to the patient. Preferably, the computerized electronic server is accessible via a device. Preferably, the device is a computer or a hand-held electronic device. Preferably, the computerized electronic server is a website. Preferably, the computerized electronic server may be configured to perform the steps of: receiving the patient clinical and demographic information; integrating with one or more electronic medical records systems; communicating insurance verification to the health care provider; contacting a pharmacy to determine whether the script is dispensed; notifying the agency when the script is dispensed; receiving one or more adverse events reports; communicating with the agency and the patient; providing reminders to the patient to take the script; and/or providing reminders to the patient that the script is about to run out. Preferably, the agency performs the step of educating the patient regarding the script after receiving notification that the script is dispensed; the agency performs the step of monitoring compliance after receiving notification that the script is dispensed; and/or the agency performs the step of comparing script provided by the health care provider with standard federal drug administration (“FDA”), National Comprehensive Cancer Network (“NCCN”), and pharmaceutical protocols. In one aspect of the present invention, the patient is a cancer patient and the script is a cancer drug.

In a preferred embodiment, a system of authorizing and monitoring drug treatments for at least one patient is provided. Preferably, the system includes a database of patient information; a database of script information; and an Internet website accessible via a computer for authorizing and monitoring drug treatments; wherein the Internet website is configured to receive at least one script provided by a health care provider; verify the patient's health insurance; determine whether the script is dispensed to the patient; and follow-up with the patient regarding compliance and adherence to the script. Preferably, the system includes an agency for coordinating care between the patient and the health care provider. Preferably, the database of script information includes standard Federal Drug Administration, National Comprehensive Cancer Network, and pharmaceutical protocols. Preferably, the Internet website is configured to receive patient information; communicate insurance verification to the health care provider; determine whether the script is dispensed to the patient by contacting the pharmacy; and/or determine whether the script is dispensed by contacting the patient.

### BRIEF DESCRIPTION OF THE DRAWINGS

The invention may be more readily understood by referring to the accompanying drawing in which:

FIG. 1 is a block diagram of a system and method of authorizing and monitoring drug prescriptions and treatments in accordance with a preferred embodiment of the invention;

FIG. 2 is a block diagram of a computer system that may be used for implementing the system of and method of authorizing and monitoring drug prescriptions and treatments of FIG. 1 configured in accordance with a preferred embodiment of the invention;

FIG. 3 is a network diagram illustrating a network of computer systems that may be used for implementing the system and method of authorizing and monitoring drug prescriptions and treatments; configured in accordance with a preferred embodiment of the invention;

FIGS. 4A and 4B are block diagrams of the system and method of FIG. 1; configured in accordance with a preferred embodiment of the invention;

FIG. 5 is a block diagram of a patient flow map of the system and method of FIG. 1, configured in accordance with a preferred embodiment of the invention;

FIG. 6 is a block diagram of the compliance component of the system and method of FIG. 1, configured in accordance with a preferred embodiment of the invention;

FIG. 7 is a block diagram of an application server of the system and method of FIG. 1, configured in accordance with a preferred embodiment of the invention;

FIG. 8 is a block diagram of the co-pay card activation component of the system and method of FIG. 1; configured in accordance with a preferred embodiment of the invention;

FIG. 9 is a block diagram of a part of the system and method of FIG. 1, configured in accordance with a preferred embodiment of the invention;

FIG. 10 is a block diagram of a part of the system and method of FIG. 1, configured in accordance with a preferred embodiment of the invention; and

FIG. 11 is a block diagram of a part of the system and method of FIG. 1, configured in accordance with a preferred embodiment of the invention.

Like numerals refer to like parts throughout the several views of the drawings.

### DETAILED DESCRIPTION OF THE PREFERRED EMBODIMENTS

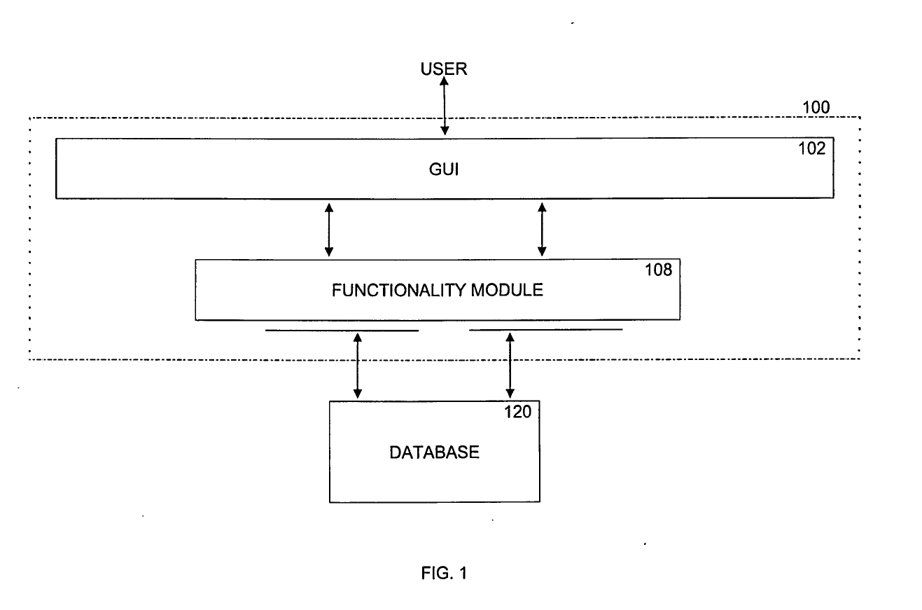

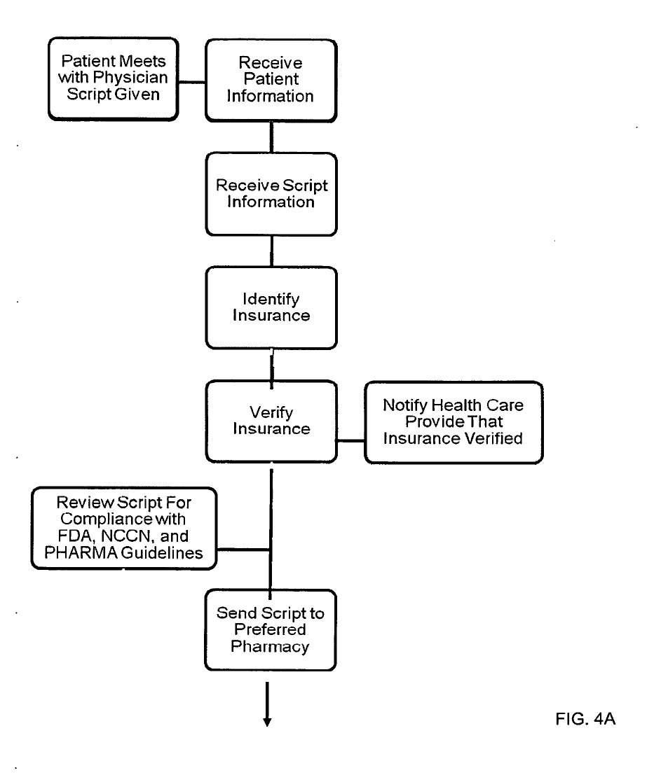

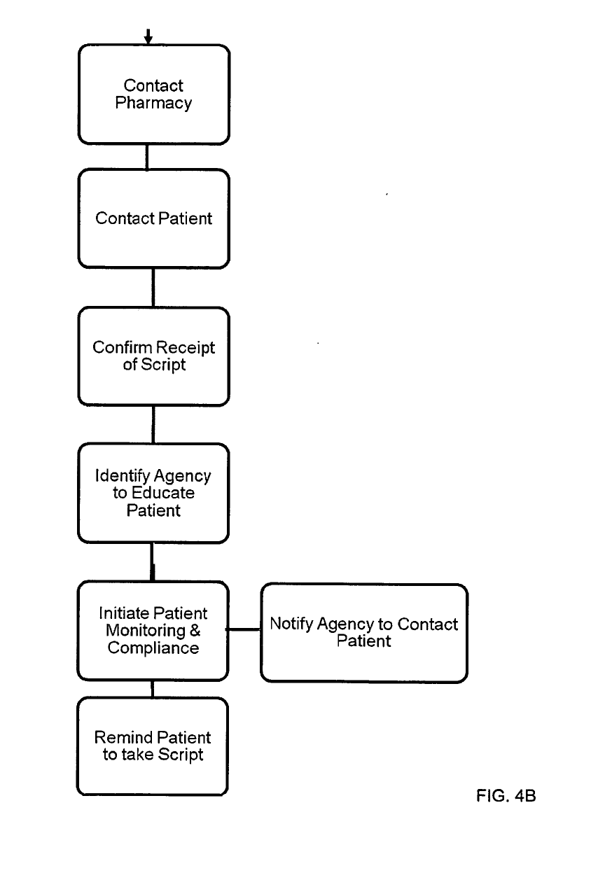

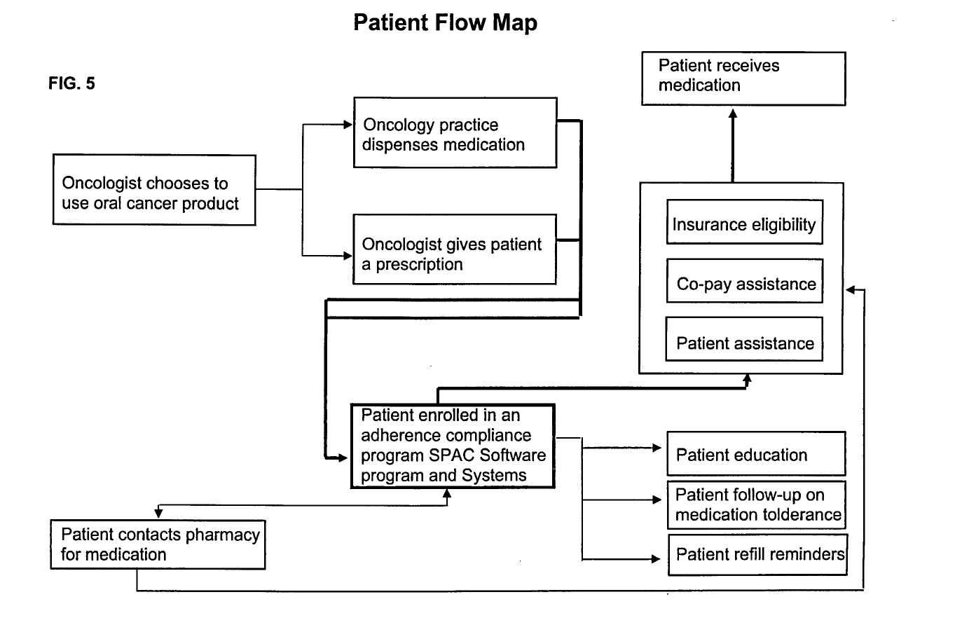

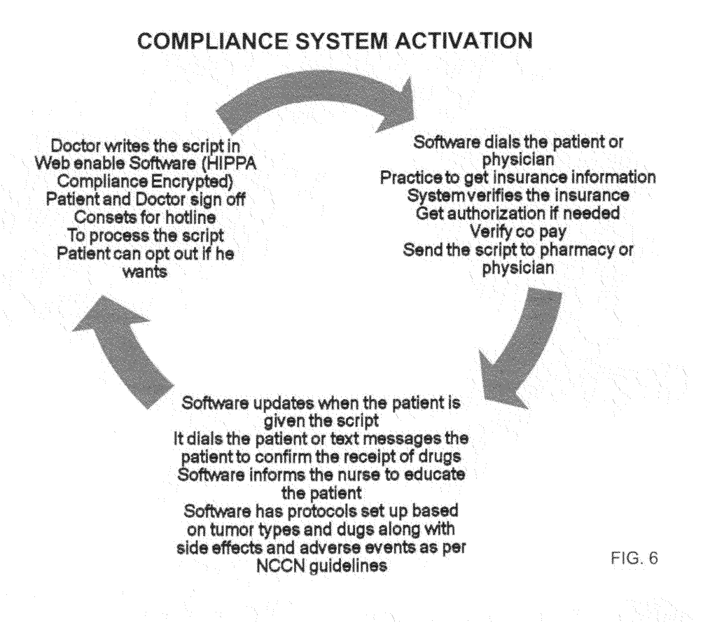

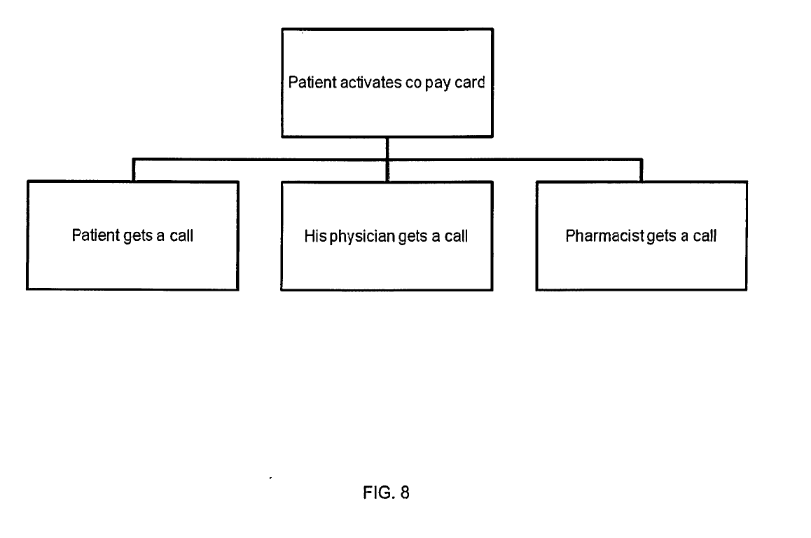

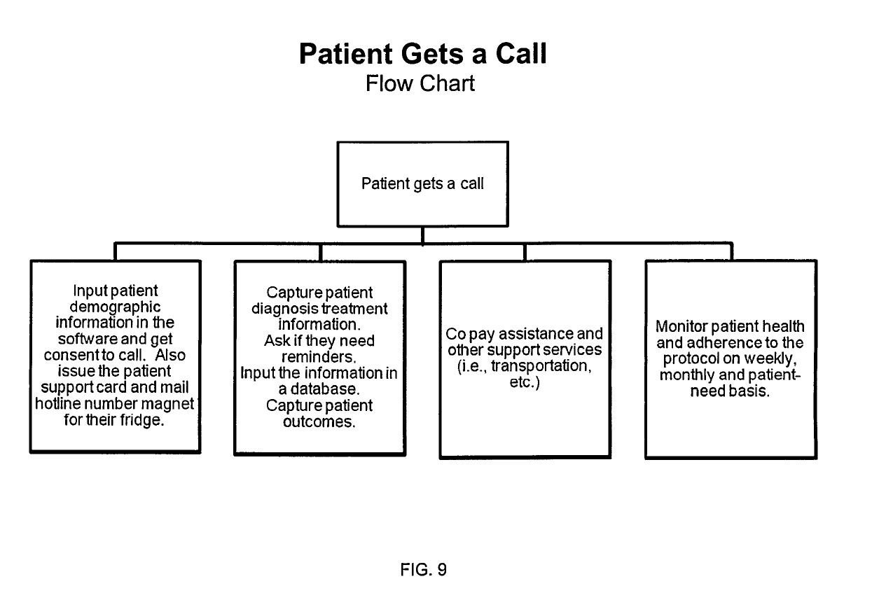

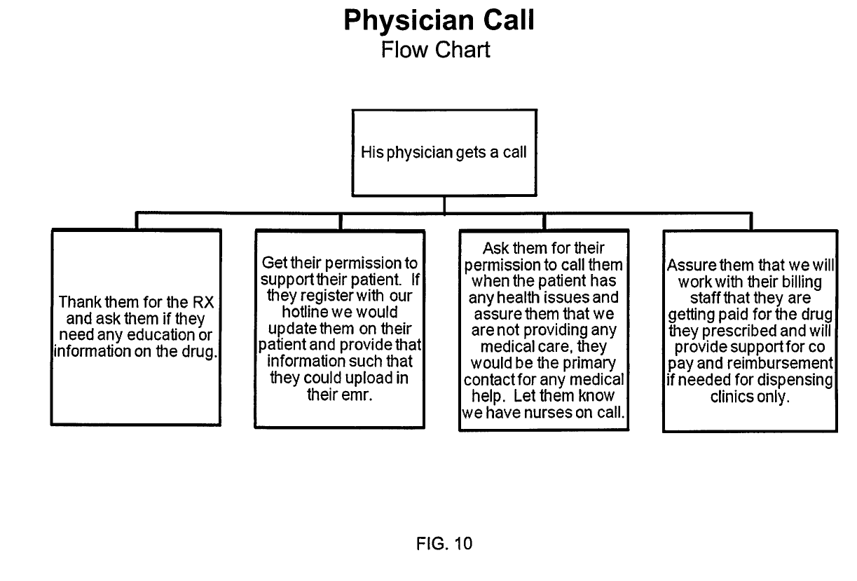

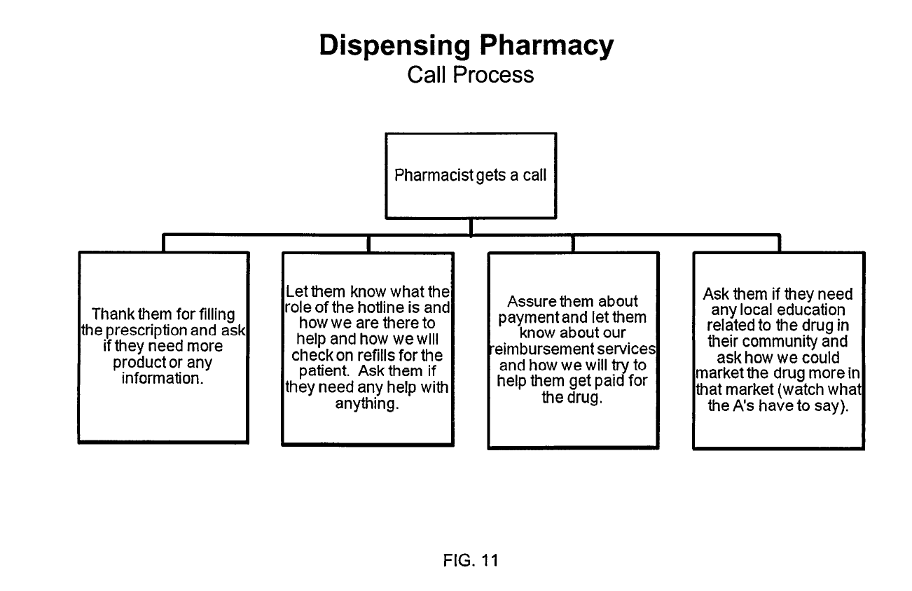

Referring to FIGS. 1-11, the present invention is directed to a system and method of authorizing and monitoring drug prescriptions and treatments for at least one patient, or a plurality of patients (also referred to, and interchangeable with, “system and method for monitoring authorization, compliance, and adherence of drug prescriptions and treatments”). As such, “method(s) of authorizing and monitoring drug prescriptions and treatments” may be interchangeable with “method(s) for monitoring authorization, compliance, and adherence of drug prescriptions and treatments.” As used herein, “plurality” means “one or more.” As used herein, “patient” may refer to one or more than one patients; and/or any other person/entity that is assisting the patient and/or taking care of the patient, and/or authorized to act on the patient's behalf. For example, as used herein, “patient” may refer to a caregiver, a parent, a health care provider, and/or any other third party that is taking care of the patient. The system and methods of the present invention preferably include the use of an agency and a computerized electronic server for authorizing and monitoring drug prescriptions and treatments and/or monitoring authorization, compliance, and adherence of drug prescriptions and treatments. In other embodiments, “patient” may only refer to the person treated (and not a third party).

As used herein, “computerized electronic server” or “electronic server” may refer to a website, such as an Internet website, web-enabled software, and/or any other electronic medium. Preferably, the computerized electronic server is encrypted and compliant with the Health Insurance Portability and Accountability Act (“HIPAA”). Preferably, the software is encrypted using SPAC software, or any other application for file encryption and sharing. As used herein, “computerized electronic server” may also refer to a local area network or cell phone network.

As used herein, “agency” preferably refers to an entity that coordinates care between health care providers and patients. It is interchangeable with “monitoring agency.” It may refer to the group itself, and/or it may refer to one or more individuals within the group, such as a nurse. It is preferably comprised of one or more live individuals. Preferably, the agency includes a plurality of physicians and a plurality of nurses. Preferably, the agency does not provide medical advice. As such, it may service patients across state lines. Preferably, the agency assists the patient in complying with his or her drug treatment regimen by communicating with the patient, educating the patient regarding the drug, monitoring patient compliance with the drug treatment regimen, reminding the patient to take the drug, etc. Preferably, these communications are triggered by the website described herein.

In a preferred embodiment, the drug authorization and treatment regimen disclosed herein may be accessible through cloud computing (i.e., virtual server). For example, cloud computing may provide a secure server for the patient, health care provider, agency, and the like. Cloud computing may serve to store and operate all of the GUIs, software, and databases. In other embodiments, cloud computing and/or a virtual server may not be used. As such, the server may be a physical computer having Internet access. In yet other embodiments, cloud computing may be used in connection with something else.

As used herein, “device” may refer to a computer, such as a tablet computer, desktop computer, laptop computer, cell phone, smart phone, hand-held device, personal digital assistant, remote control, television set, set top box, mobile network, phone, data, photographic scanning systems; or any other device for viewing an electronic server such as a website. Preferably, the device is a computer. For example, the electronic server of the present invention may be provided in the form of an iPhone application and viewed on a device such as an iPhone. Preferably, the electronic server displays a graphical user interface (“GUI”).

A graphical user interface is a type of user interface that allows people to interact with programs in more ways than typing. The user generally is able to access the GUI by entering a secure website on the Internet, or any other electronic server. It is to be understood that the GUI may be accessed via any web-enabled device, such as a computer, iPhone, PDA, or the like. Preferably, the GUI is displayed on an Internet website accessible via a computer (as used herein, “an Internet website accessible via a computer” may mean “an Internet website on a computer” [or any other web-enabled device]).

FIG. 1 is a block diagram of a system 100 of authorizing and monitoring drug prescriptions and treatments in accordance with an embodiment of the present invention. The system 100 includes a graphical user interface 102 coupled to a functionality module 108. The GUI 102 provides a user with access to information stored in a database 120 using the functionality provided by the functionality module 108. As further described below, in one embodiment, the database 120 stores information in one or more related databases that are logically grouped by predetermined areas. These areas may be for example, patient information, drug information, insurance information, and the like. As used herein, “database” should be understood to cover reference to a single database or a collection of databases. In other embodiments, information may be stored or arranged using a variety of data storage software and hardware techniques known to those of ordinary skill in the art of database programming. For example, one database system that may be used with the present invention is the SQL Server system as offered by Microsoft Corp. Other data storage systems, such as those based on Oracle Database products offered by Oracle Corporation or the MySQL database server offered by MySQL AB, may be used. These data storage systems run on a variety of hardware platforms, including those based on the microprocessors offered by Advanced Micro Devices2, Inc., or Intel Corp.

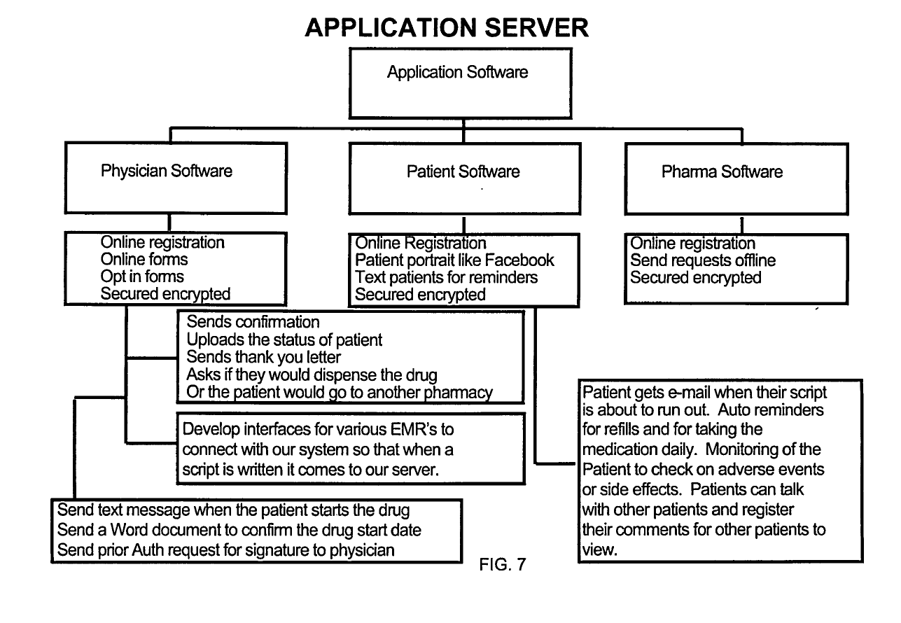

Referring to FIG. 1, the database 120 is preferably accessible by the functionality provided by the functionality module 108 in the system 100. The user accesses the functionality module 108 through the GUI 102, as described herein. For example, the functionality module 108 may be a software system for providing at least one patient a drug authorization and treatment regimen. Information regarding drug authorization and compliance may be displayed on the GUI 102. Preferably, the functionality module 108 is a single software system. In other embodiments, and referring to FIG. 7, the functionality module 108 may represent more than one software system. For example, it may represent an application software that includes physician software, patient software, pharma software, and/or insurance software.

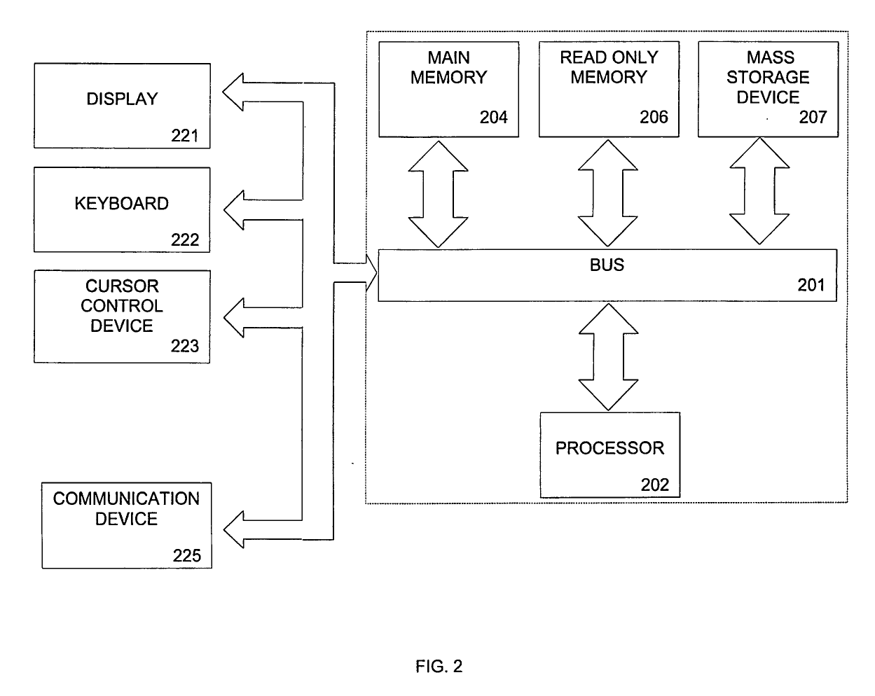

In a preferred embodiment, FIG. 2 illustrates an example of a computer system 200 in which the features of the present invention may be implemented. The computer system includes a bus 201 for communicating information between the components in the computer system 200, and a processor 202 coupled with the bus 201 for executing software code, or instructions, and processing information. The computer system further comprises a main memory 204, which may be implemented using random access memory (RAM) and/or other random memory storage device, coupled to the bus 201 for storing information and instructions to be executed by the processor 202. The main memory 204 may also be used for storing temporary variables or other intermediate information during the execution of instructions by the processor 202. The computer system 200 includes a read only memory (ROM) and/or other static storage device coupled to bus 201 for storing static information and instructions for processor 202. Another type of user input shown in the figure is a cursor control device 223, such as a conventional mouse, touch mouse, trackball, track pad, or other type of cursor direction keys for communicating direction information and command selection to the processor 202 and for controlling movement of a cursor on the display 221. Although not illustrated, the computer system 200 may optionally include video, camera, speakers, sound card, and many other conventional multimedia options. Various types of input devices, including, but not limited to the input devices described herein, unless otherwise noted, allow the user to provide command or input to the computer system 200. For example, in the various descriptions contained herein, reference may be made to the user “selecting,” “clicking,” or “inputting,” and any grammatical variations thereof, one or more items in a user interface. These should be understood to mean that the user is using one or more input devices to accomplish the input.

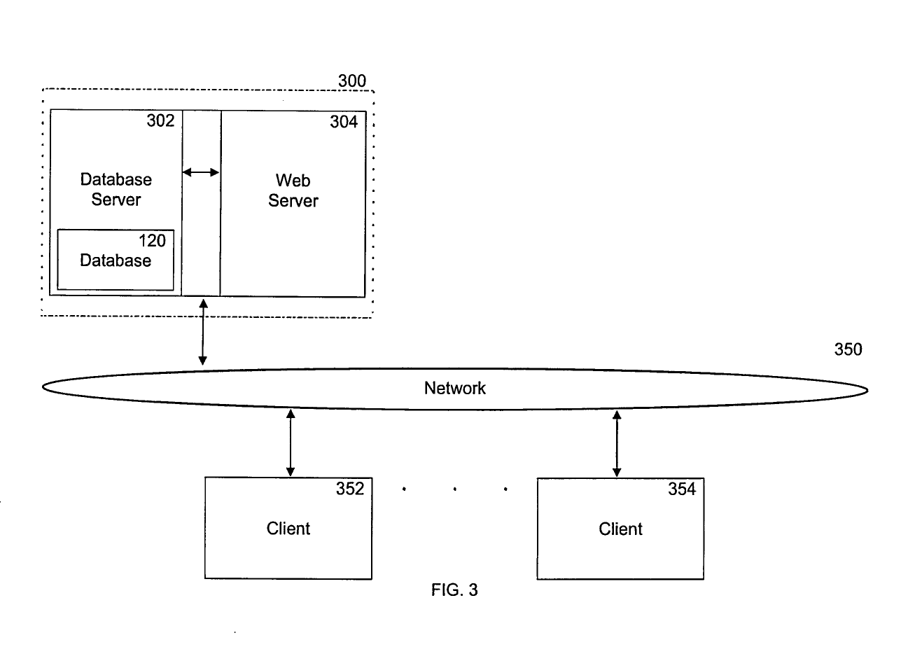

In accordance with one embodiment, FIG. 3 illustrates a computer network including a server system 300 having a database server 302 for storing a database 120 and a web server 304 that stores the instructions necessary to access and present information from, as well as store information into, the database 120. The user, using a client computer such as a client 352 and a client 354, accesses server system 300 through a network 350. Other systems, such as those belonging to a manufacturer may also be coupled to the server system 300. In the illustrated embodiment, the network 350 represents a variety of networks that may include one or more local area networks as well as wide area networks. The functionality provided by the database server 302, the web server 304, the client 352 and the client 354, as well as by the manufacturer, may be implemented using a computer system having the characteristics of the computer system 200 described herein. It should be noted, however, that the specific implementation of the computer system or systems used to describe the present invention is not to be limiting unless otherwise specifically noted. For example, the functionality provided by the database server 302 and the web server 304 may be offered by one computer system. Further, the functionality provided by the database server 302 and 304 may be redistributed over several computers.

In a preferred embodiment, the user may interact with the information stored in the database 120 through the GUI 102. In the following description, the GUI 102 is implemented using one or more web pages (which may be referred to herein as “pages,” “screens,” or “forms”) provided by the web server 304 accessible by the user using any Internet web browser software, such as the Internet Explorer browser provided by Microsoft Corp., on client computer such as the client 352. In another embodiment, one or more custom software programs can be created to implement the system described herein. Of course, the web server itself may have browser software installed on it so as to be accessed by the user. Further, throughout the description of the various embodiments of the invention described herein, references are made to the user performing such actions as selecting buttons or clicking on, executing searches or updates on the database 120. In one preferred embodiment, these requests are generated by the user interacting with the browser. Preferably, the one or more web pages described herein may include a form interface (e.g., a drop down menu, a radio button selection, etc.). Once the user has provided such selection, the user may select a button or a link on the web page to request an update of the database 120 with the information. The browser will send the web server 304 a link that includes the information (i.e., the user's selection) being sent as well as the request to update the database 120.

Throughout the description of the various embodiments of the invention described herein, references are made to the computerized electronic server (or website) “updating,” or a grammatical variation thereof. This reference preferably means that the system is taking note of the new information and updating the patient database and/or other database and particularly that patient's profile, regarding the new information. These “updates” may be triggered manually, automatically, and/or passively. As used herein, “manually,” or a grammatical variation thereof, refers to one or more individuals interacting with the website to update, for example, a patient profile. As used herein, “automatically,” or a grammatical variation thereof, refers to the website updating, for example, a patient profile on its own, i.e., if a patient confirms receipt of the script. For example, should the computerized electronic server contact the patient to confirm receipt of the script, and should the patient confirm receipt via, for example, text message or email, the server may “update” to reflect patient that the patient has received the script. Preferably, this means that the particular patient's profile is updated to reflect that the patient has received the script. As such, an electronic note may be made in the patient file. Preferably, this update triggers a host of other actions. This update, for example, may in turn notify the agency to contact the patient and educate him or her regarding the drug. Additionally, it is to be understood that the website may be updated, i.e., the patient profile may be updated, passively, without any affirmative or negative action. For example, the website may update with new information on a patient at predetermined time intervals, i.e., after a script is received, the website may update on its own after a predetermined period of time. Preferably, the drug authorization and treatment regimen disclosed herein updates manually, automatically, and passively. In other embodiments, the drug authorization and treatment regimen may update manually, automatically, and/or passively.

In a preferred embodiment, and as discussed above, a “user” is able to enter and/or access information on the Internet website using any computer, mobile device, or any other device capable of displaying an Internet website, or other electronic medium. As used herein, “user” may refer to one or more of the following: a patient, health care provider, payor, pharmaceutical company, drug manufacturer, pharmacy, agency, and/or the like. Preferably, the user is a patient, health care provider, or the agency. Preferably, the patient is a cancer patient. Preferably, the Internet website is a secure website, and user LOG IN information determines what information that particular user is privy to, what webpages he or she is directed to, and/or what information he or she can input. For example, the patient may have access to only his or her information; however, the health care provider and/or agency may have access to a panel of patients. In this manner, the GUI for the Internet website may appear the same for each entity; however, depending on the entity's identity, he or she may have access to some information, but not all. In other embodiments, the GUI may be tailored and/or customized depending on the type of entity seeking access, such as health care provider or agency. Additionally, it is to be understood that information may be entered, i.e., typed in, or “selected” from, for example, a drop-down menu or the like. As such, as used herein, “enter” may refer to “select” or the like.

Reference is made of the agency and/or the computerized electronic server “contacting,” or any grammatical variation thereof, the patient, the health care provider, the pharmacy, the agency, insurance company, or the like. As used herein, “contacting,” or any grammatical variation thereof, may refer to “calling,” “texting,” “emailing,” and the like. It is to be understood that the “contacting” may be done in an automated manner, i.e., via the computerized electronic server, and/or the “contacting” may done by a live person (i.e., someone in the agency). For example, the “contacting” may be done via an autophone, automated text message and/or email from the website, or via phone, email, and/or text message from an individual at the agency. For example, the website may be triggered to send the patient an automated text message to confirm receipt of the script.

Reference is made to the agency and/or the computerized electronic server “notifying,” or any grammatical variation thereof, the patient, the health care provider, the pharmacy, the agency, insurance company, or the like. As used herein, “notifying” may refer to “contacting,” or any grammatical variation thereof, one or more entities, such as the patient, health care provider, pharmacy, agency, insurance company, or the like. It is to be understood that the “notifying” may be done in an automated manner, i.e., via the computerized electronic server, and/or in a manual manner via human contact. The notification and/or contact may trigger another automatic or manual action.

As used herein, “notifying” and/or “contacting,” or any grammatical variations thereof, may also refer to “making information available” and/or “updating” the system. For example, once the patient confirms receipt of a script, the system may simply update the patient's profile to reflect the same. When an individual in the agency is ready to contact the patient, the individual may review the patient's profile to see that he/she has confirmed receipt of the script. As such, the agency is not proactively notified about the patient's receipt of the script, but the information is available to it. It is to be understood that any information that may be available through “notifying” and/or “contacting,” as used herein, may also be available passively, i.e., by logging onto the website, to someone who seeks it. As such, reference to “notifying,” and “contacting” may also mean “making information available.”

As used herein, “patient information” may refer to patient demographic and/or clinical information. It may refer to information entered by the patient, health care provider, and/or agency, and/or it may refer to information retrieved from an electronic medical records system.

As used herein, “script,” or any grammatical variation thereof, refers to, and is interchangeable with, “drug,” “prescription,” “medical prescription,” “medication,” grammatical variations thereof, and the like. Preferably, “script” refers to a cancer drug such as, but not limited to, Tarceva, any chemotherapeutic drug, and the like. It may refer to any drug now known or later developed. Additionally, “script” may refer to a drug treatment plan. Preferably, it refers to cancer treatment plans, such as, but not limited to, taking a drug for five days and consuming no grape juice while under treatment. It may also refer, for example, to long-term chemotherapetic drug treatment, hormone treatment, and/or radiation treatment. It may refer to any treatment plans now know or later contemplated.

As used herein, “drug information” may refer to identity and/or dosing regimen for the drug prescribed; and/or standard protocol information regarding the drug from the Federal Drug Administration (“FDA”), National Comprehensive Cancer Network (“NCCN”), insurance company, pharmaceutical company, and/or any other entity. “Drug information” may refer to treatment pathways or guidelines developed by health plans/health providers/health associations and/or health organizations.

As used herein, “drug treatment regimen” may refer to the system and methods of the present invention. As used herein, “drug treatment regimen” is interchangeable with “drug authorization and treatment regimen,” “regimen,” “program,” “website,” “system,” and/or “computerized electronic server.” For example, “drug treatment regimen” may include both the agency and the computerized electronic server described herein. It is to be understood, however, that it may also refer to the computerized electronic server, i.e., website, alone.

As used herein, “health care provider” preferably refers to an oncologist. In other embodiments, as used herein, “health care provider” may refer to a physician of any specialty (or an internist/family practioner), nurse practitioner, nurse, clinician, physician's assistant, medical assistant, and the like. “Health care provider” may also refer to a physician's office/practice, a hospital, and the like.

In a preferred embodiment, the invention described herein generally operates as follows. A health care provider, such as a physician, prescribes a medication to a patient. Preferably, the patient is then given the option to join the drug authorization and treatment regimen described herein. Should the patient decide to join, he or she will have access to a computerized electronic server and an agency that coordinates/monitors his or her care with the health care provider. In other embodiments, the agency is omitted, and the care is coordinated via the computerized electronic server alone. As such, it is to be understood that the agency may be omitted.

The invention will be described in detail below.

In a preferred embodiment, the health care provider subscribes to the drug authorization and treatment regimen described herein. Should the health care provider be accessing the website for the first time, the health care provider may be directed to a SIGN IN or LOG IN page that directs the the health care provider to enter his or her name, practice information, etc. In subsequent visits, preferably, the health care provider is not required to enter this information, as it is stored in the server. Preferably, the health care provider has access to certain information due to his or her status as a health care provider. The information accessible by the health care provider may be different from the information accessible by the patient. For example, the health care provider may have access to the health information of many patients. In this manner, for example, the health care provider may have access to different features once he or she logs on due to the fact that he or she is a health care provider.

In a preferred embodiment, during and/or after registration, the website is configured to connect with, and/or sync to, the health provider's electronic medical records system(s), referred to herein singularly and plurally as “EMR.” As such, patient information may be retrieved from the electronic medical records system(s) and uploaded to the website. For example, a hospital language 7 (“HL7”) interface may connect an EMR to the system of the present invention. Each EMR vendor has to comply with the HL7 interface. This may be bidrectional, where the data flow is between the EMR and the system of the present invention and between the system of the present invention and the EMR and/or this may be unidirectional, where the data flow is only from the EMR to the system of the present invention. In other embodiments, rather than the use of HL7, any other means of connecting an EMR with the system of the present invention may be used. In yet other embodiments, the interface and/or connection (i.e., HL7) is not needed and/or omitted. In this regard, the agency may have access to the health provider's EMR (i.e., via manual log in rights). It is to be understood, however, connection with the health provider's electronic medical records system(s) may be omitted. In other embodiments, the website is not configured to connect with, and/or sync to, the health provider's electronic medical records system(s).

In a preferred embodiment, the website is configured to receive pharmacy information from the health care provider. Specifically, the system asks the health care provider if he/or she would be dispensing the drugs, if a patient's selected pharmacy would be dispensing the drugs, and/or if it would be determined on a case-by-case basis. For example, some health care providers may have a pharmacy on site, and patients only get medications from that pharmacy. In that instance, the health care provider would be dispensing the drugs. In other embodiments, the website is not configured to receive pharmacy information from the health care provider.

In a preferred embodiment, the health care provider provides the patient with the option of joining the drug authorization and treatment regimen described herein during the patient visit. This may be done in a number of ways. The health care provider may provide the patient with registration information, the link to the website, and/or a number to call the agency. In other embodiments, rather than an opt-in option to join, the patient may be given an opt-out option. In yet other embodiments, the health care provider may contact the patient to inform the patient of his or her subscription to the drug authorization and treatment regimen, and the patient may be able to subscribe from outside the health care provider's office. In yet other embodiments, the patient may be given a number to call and/or other contact information if he or she wants to join. For example, the patient may be given the number to the agency, and the agency may be able to register the patient. During the registration process, the agency may input patient demographic information, obtain authorization from the patient to contact him or her, provide co-pay assistance, provide information on transportation assistance, and the like. In yet other embodiments, payors may require and/or request that their patients join the program.

In a preferred embodiment, if the patient decides to join, he/she enters her information onto the website via a computer. Should the patient be accessing the website for the first time, the patient may be directed to a SIGN IN or LOG IN page that directs the patient to enter his or her name, demographic and/or clinical information. In subsequent visits, preferably, the patient is not required to enter this information, as it is stored in the server, patient database, or the like. In other embodiments, the patient does not enter his or her information. Rather, the patient's information may be extracted/populated/uploaded from one or more electronic medical records systems that may be connected to the website. Preferably, patient information entered includes patient health insurance information. In yet other embodiments, the patient may enter some information, and some information may be extracted/populated/uploaded from an electronic medical records system. In yet other embodiments, the patient may not need to input a log in and/or a password and/or the homepage may have another means for registering a new user. In yet other embodiments, patient information may not be entered by the patient, i.e., it may be entered by the agency or other entity.

In a preferred embodiment, the website, particularly the patient portal, is configured to allow patients to chat with other patients. For example, the chat rooms may be educational chat rooms discussing diseases or the like, and/or social chat rooms. The chat rooms may allow patients that have difficult disease conditions, such as cancer, to connect with each other, share and/or upload stories. The chat rooms may be accessible when the patient logs in to the Internet and/or they may be accessible when the patient logs in to the website. Preferably, the patient portal is akin to Facebook, but with an emphasis on patients and disease. In other embodiments, the patient portal is not configured to allow patients to chat with other patients.

In a preferred embodiment, the website is configured to receive script information. Preferably, the health provider enters the script information during the patient visit. In this regard, the website may be available via a computer in the patient's room. In other embodiments, the health care provider may not enter the script information during the patient visit. For example, the patient may opt-in to the program at home, and the health care provider may be notified of the patient's enrollment in the program. The health care provider may then enter the script information onto the website.

In a preferred embodiment, after script information is received, the agency may contact the health provider to obtain permission to contact the particular patient or a group of patients. Additionally, the agency may contact the health provider to determine if he or she needs additional education on the script. In other embodiments, the system itself automatically contacts the health care provider to obtain permission to contact the particular patient. In yet other embodiments, health provider permission is not obtained. In this regard, permission may be implied from the health provider's registration into the program.

In a preferred embodiment, the website is configured to identify patient insurance information. Preferably, once a script is received, the website is updated. The system is thereafter triggered to identify patient insurance information. Preferably, the patient enters his or her insurance information during the registration process. This information may be retrieved from the patient on the server and/or the electronic medical records system that is connected to the website. Patient health insurance information may also be obtained from the patient's health care provider. It may be retrieved automatically and/or manually. In yet other embodiments, patient insurance information is not identified. In yet other embodiments, patient health insurance information is identified prior to the receipt of the script, i.e., after the patient enrolls in the program.

In a preferred embodiment, the website is configured to verify patient insurance. Preferably, after the insurance information is identified, and it is determined that a script is received, the system may trigger the insurance verification process. For example, after the insurance information is identified, the system may notify the agency to contact the identified insurance company to verify coverage, i.e., to verify that the particular patient has insurance and/or to verify that the patient's insurance company covers the script and/or treatment ordered by the health care provider. Preferably, the agency notifies the health care provider as to whether the script and/or treatment is covered by the particular patient's health insurance. In this manner, if the script and/or treatment is not covered, then the health care provider and/or agency may contact the patient to determine an alternate course of action, or the like. In this way, patients that are very ill, i.e., cancer patients, who may be discouraged from seeking alternate treatment should their insurance not accept a prescribed script, may be contacted by the health care provider to discuss alternate plans. Additionally, if there is an unpaid bill or co-pay involved, the agency may notify the patient and/or health care provider. For example, the website may be configured to search resources and/or the agency may search resources that may be able to provide a portion or all of the patient's co-pay, i.e., if the patient cannot afford to pay it. These resources include, but are not limited to, resources available in the industry, pharma, charitable organizations, co-pay foundations based upon, i.e., disease types, etc. Preferably, the agency determines patient need by, for example, determining patient ability to pay (i.e., by reviewing patient income information). After it is determined that a patient needs co-pay assistance, the system may automatically search, for example, a database of resources, and/or the agency may itself identify resources for a particular patient. In other embodiments, the patient's health information is not verified by the system and methods of the present invention. In yet other embodiments, the agency does not notify the health care provider if the prescribed script and/or treatment is covered by the patient's health insurance. In yet other embodiments, the step of notifying the health care provider, patient, and/or insurance company regarding any outstanding co-pay is omitted.

In a preferred embodiment, the patient script and treatment information is reviewed by the agency for compliance with certain guidelines. Preferably, this review occurs after insurance information is identified and verified. Preferably, a physician at the agency reviews the script for compliance with Federal Drug Administration, pharma, insurance, National Comprehensive Cancer Network guidelines, and/or any other guidelines. Preferably, the guidelines to be complied with will depend on the script and/or treatment. If the script and/or treatment information are non-compliant, and/or a question exists as to whether the script and/or treatment is compliant or not, then the health care provider treating the patient may be notified. In other embodiments, someone other than a physician at the agency reviews the script and/or treatment information. In yet other embodiments, the script and/or treatment information is reviewed electronically. In yet other embodiments, the pharma or drug company does not have access to the website. In this regard, the agency may input pharma guidelines into the website. In yet other embodiments, the script and/or treatment information is not reviewed for compliance with FDA, pharma, insurance, and/or NCCN guidelines. In yet other embodiments, the script and/or treatment information is reviewed prior to, or independent of, insurance identification and/or verification.

In a preferred embodiment, the website is configured to send the script to the patient's selected pharmacy. Preferably, this happens after the insurance information is verified. For example, the system may notify the agency to contact the pharmacy to fill the script and/or the system itself may automatically contact the pharmacy to fill the script. For example, the agency may be notified that it needs to contact a particular pharmacy regarding a particular patient's script. The pharmacy may be directed to fill the script with or without human intervention. In other embodiments, the script is not sent to a pharmacy, i.e., it may be sent to any other entity to fill, such as the health care provider. In yet other embodiments, the website is not configured to send the script to the patient's selected pharmacy.

In a preferred embodiment, the website is configured to contact the pharmacy to determine if the pharmacist or other worker would like to be educated regarding the script. Preferably, the website is configured to contact the pharmacy to determine if the pharmacist or other worker would like to be educated regarding the script before the patient picks up the script. For example, receipt of the script, insurance identification, and/or insurance verification may trigger the system to notify the agency to contact the pharmacy to educate it regarding the particular patient, drug, and/or treatment. As such, someone at the agency may call the pharmacist and ask the pharmacist whether they would like to be educated regarding the drug to be dispensed to the patient. In this manner, the pharmacist may be able to convey any new information or reiterate old information regarding the drug to the patient when the patient comes to pick up the medication. In this manner, the patient may be educated regarding the drug another time, outside of the health provider's office. In other embodiments, the system may automatically, i.e., electronically, contact the pharmacy to see if the pharmacist would like to be educated regarding the script. In yet other embodiments, the website is not configured to determine if the pharmacist or other worker would like to be educated regarding the script.

In a preferred embodiment, the website is configured to determine if the script was dispensed to the patient. In this regard, for example, the website may be configured to contact the pharmacy. Preferably, once the script is received and/or once insurance information is identified and/or verified, the system is updated. This may trigger the system to determine if the script is dispensed. For example, the website may be configured to notify the agency that it needs to contact the pharmacy to determine if the script was dispensed and/or the website may be configured to automatically contact the pharmacy to determine if the script is dispensed. This notification may happen, for example, after the script is received and/or after insurance information is identified and verified. For example, the website may be configured to send an automated call to the pharmacy, and the pharmacist or other worker can confirm that the script was dispensed to the patient by, for example, pressing a certain button on the phone.

In a preferred embodiment, the website is configured to determine if the patient received the script. For example, after it has been determined that the script has been dispensed to the patient, and the system has been updated to reflect the same, then the system is triggered to contact the patient, i.e., electronically or via text message, to confirm receipt of the drugs, preferably within a set period of time. Once the patient confirms receipt, the system is updated to reflect that the patient has indeed received the medication. In other embodiments, the system and/or agency does not contact the patient to confirm if the script has been received. Instead, for example, the agency may contact the pharmacy to determine if the script was filled or dispensed to the patient. Thereafter the agency may update the system, say for example, if the script was picked up. This may trigger the system, after a predetermined period of time, to contact the patient, for example, to notify the agency to educate the patient and/or to monitor compliance as discussed further below.

In a preferred embodiment, the agency educates the patient regarding the drug treatment. Preferably, this occurs after the pharmacy and/or patient is contacted to determine if the script was dispensed to the patient and/or received by the patient. For example, the system may be triggered to notify the agency to educate the patient once it is determined that the script has been dispensed to the patient and/or received by the patient. Preferably, once the agency receives notification that the script is dispensed and/or received, the agency, preferably, a nurse at the agency, contacts the patient to educate the patient regarding the script and treatment plan. This contact preferably occurs within a predetermined time period following notification that the script is dispensed to the patient and/or received by the patient. Preferably, this contact serves as another tier of drug treatment education for the patient. In this manner, the patient is educated/reminded of the drug treatment even after leaving the health care provider's office. In other embodiments, the system notifies the agency to educate the patient prior to, or without, patient confirmation of receipt of the script. In yet other embodiments, the patient is not educated regarding the script and/or regarding the treatment plan, and/or the system itself does not notify the agency to educate the patient, i.e., the agency educates the patient on its own volition, for example after the health care provider inputs script information into the system.

In a preferred embodiment, the website is configured to monitor patient compliance and/or adherence with the drug and treatment plan. Preferably, once the patient confirms receipt of the script, the website notifies the agency to monitor compliance. The agency may monitor compliance in a number of ways. For example, the agency may contact the patient at predetermined time intervals to determine if the patient is taking the medication, to determine if the patient has any questions or concerns regarding the medication, and/or to remind the patient to take or refill the medication. The agency may also monitor medication tolerance. In other embodiments, the system itself may automatically contact the patient, i.e., via email and/or text message, to determine if the patient has taken the medication at the prescribed time intervals, to remind the patient to take the medication at prescribed time intervals, and/or to remind the patient to obtain a refill. For example, once the patient confirms receipt of the script, and the system is updated regarding the same, then the system may be triggered to send the patient automatic reminders, i.e., via text message and/or email, to take the medication. In other embodiments, patient compliance is not monitored, and/or it is monitored via the agency or via automatic reminders, but not both. In yet other embodiments, the automatic reminders are sent to the patient's secure website, in lieu of, or in connection with, the automatic reminders sent to the patient's email or phone. For example, if the automatic reminders are sent to the patient's website only, then the patient will only get the reminder if he or she logs into the website. In yet other embodiments, patients may be able to choose how compliance may be monitored, i.e., upon registration. In yet other embodiments, other events in lieu of, or in connection with, patient receipt of the script triggers the system to notify the agency to monitor patient compliance with the drug and treatment plan.

In a preferred embodiment, the website is configured to monitor and report adverse events (“AE”). For example, the agency, during a routine contact with the patient, may become aware of an AE, or what may be considered an AE. Accordingly, the agency may report the AE to the patient's health care provider, a regulatory agency, and/or any other appropriate entity. In other embodiments, in addition to, or in lieu of, the agency contact and AE report, the website itself may be configured to receive AE information from the patient, agency, and/or health care provider. For example, the patient may be able to log into the website and report an AE. In yet other embodiments, the system does not monitor and/or report AE information.

The foregoing embodiments are merely examples of the present invention. Those skilled in the art may make numerous uses of, and departures from, such embodiments without departing from the scope of the present invention. Accordingly, the scope of the present invention is not limited to or defined by such embodiments in any way, but rather, is defined solely by the following claims.

What is claimed is:

1. A method for authorizing and monitoring drug prescriptions and treatments for at least one patient comprising:
a. providing an agency for coordinating care between the patient and a health care provider;
b. providing a computerized electronic server for authorizing and monitoring drug prescriptions and treatments configured to perform the steps of:
i. receiving a script;
ii. verifying insurance information;
iii. determining whether the script is dispensed to the patient; and
iv. contacting the health care provider when the script is dispensed to the patient;
wherein the computerized electronic server is accessible via a device.

2. The method of claim 1, wherein the device is a computer or a hand-held electronic device.

3. The method of claim 2, wherein the computerized electronic server is a website.

4. The method of claim 3, wherein the computerized electronic server is configured to perform the step of receiving patient clinical and demographic information.

5. The method of claim 3, wherein the computerized electronic server is configured to perform the step of integrating with one or more electronic medical records systems.

6. The method of claim 3, wherein the computerized electronic server is configured to perform the step of communicating insurance verification to the health care provider after step 1b)ii.

7. The method of claim 3, wherein the step of determining whether the script is dispensed comprises the step of contacting a pharmacy where the script was sent.

8. The method of claim 3, wherein the step of determining whether the script is dispensed comprises the step of contacting the patient.

9. The method of claim 8, wherein the computerized electronic server is configured to perform the step of notifying the agency when the script is dispensed.

10. The method of claim 9, wherein the agency performs the step of educating the patient regarding the script after receiving notification that the script is dispensed.

11. The method of claim 10, wherein the agency performs the step of monitoring compliance after receiving notification that the script is dispensed.

12. The method of claim 11, wherein the computerized electronic server is configured to perform the step of receiving one or more adverse events reports.

13. The method of claim 11, wherein the patient is a cancer patient and the script is a cancer drug.

14. The method of claim 13, wherein the computerized electronic server is configured to perform the step of communicating with the agency and with the patient.

15. The method of claim 14, wherein the computerized electronic server is configured to perform the step of providing reminders to the patient to take the script.

16. The method of claim 15, wherein the computerized electronic server is configured to perform the step of providing reminders to the patient that the script is about to run out.

17. A system for authorizing and monitoring drug treatments for at least one patient comprising:
a. a database of patient information;
b. a database of script information; and
c. an Internet website accessible via a computer for authorizing and monitoring drug treatments;
wherein the Internet website is configured to:
i. receive at least one script provided by a health care provider;
ii. verify the patient's health insurance;
iii. determine whether the script is dispensed to the patient;
iv. follow-up with the patient regarding compliance to the script.

18. The system of claim 17, further comprising an agency for coordinating care between the patient and the health care provider.

19. The system of claim 18, wherein the database of script information includes Federal Drug Administration, National Comprehensive Cancer Network, and pharmaceutical drug protocols.

20. The system of claim 19, wherein the agency compares the script provided by the health care provider with Federal Drug Administration, National Comprehensive Cancer Network, and pharmaceutical drug protocols.

21. The system of claim 20, wherein the Internet website is configured to receive patient information.

22. The system of claim 21, wherein the Internet website is configured to communicate insurance verification to the health care provider.

23. The system of claim 22, wherein the Internet website is configured to determine whether the script is dispensed to the patient by contacting the pharmacy.

24. The system of claim 22, wherein the Internet website is configured to determine whether the script is dispensed to the patient by contacting the patient.

25. The system of claim 22, wherein the patient is a cancer patient and the script is a cancer drug.
